(19) United States
(12) Patent Application Publication
(10) Pub. No.: US 2013/0262134 A1
(43) Pub. Date: Oct. 3, 2013

(54) INFORMATION MANAGING SERVER AND METHOD

(71) Applicant: FUJITSU LIMITED, Kawasaki-shi (JP)

(72) Inventors: Eiichi UYAMA, Osaka (JP); Michiko TADA, Osaka (JP); Kazuo YAMAKAWA, Ikeda (JP)

(73) Assignee: FUJITSU LIMITED, Kawasaki-shi (JP)

(21) Appl. No.: 13/799,867

(22) Filed: Mar. 13, 2013

(30) Foreign Application Priority Data
Mar. 30, 2012 (JP) 2012-083279

(51) Int. Cl. G06F 19/00

(52) U.S. Cl. CPC G06F 19/363
USPC 705/2

(57) ABSTRACT

An information managing server includes: a memory; and a processor configured to execute a procedure, the procedure comprising: registering, in the memory, stored doctor information including information on doctors, registrant information indicating a registrant who provides a registration request, and registration information indicating a state of registration, in accordance with the registration request, possible states of registration including at least provisional registration and definitive registration, and outputting, in accordance with a doctor information request from a user, associated doctor information that is associated with both the registration information indicating the provisional registration and the registrant information indicating the user, among the stored doctor information in the memory.

### CROSS-REFERENCE TO RELATED APPLICATION

This application is based upon and claims the benefit of priority of the prior Japanese Patent Application No. 2012-083279, filed on Mar. 30, 2012, the entire contents of which are incorporated herein by reference.

### FIELD

The embodiments discussed herein are related to an information managing server, an information management method and a computer-readable recording medium storing an information management program.

### BACKGROUND

Traditionally, in order to receive approval for production and sales of drugs and medical devices under the Federal Food, Drug and Cosmetic Act, drug trials have been conducted by pharmaceutical companies. For example, for a drug trial, a clinical trial is conducted on a drug for which approval is to be newly received, and trial information on results of the clinical trial is collected.

A case where a drug trial is conducted by a pharmaceutical company is described below. For example, the pharmaceutical company outsources a business activity related to the drug trial to an outsourcing company. The outsourcing company that receives the outsourced business activity determines a doctor in charge of the drug trial. Then, the outsourcing company outsources a clinical trial to the determined doctor in charge and conducts a monitoring task relating to the doctor in charge. In the monitoring task, a person who is in charge of the drug trial and belongs to the outsourcing company periodically consult with the doctor in charge and collects trial information on results of the clinical trial from the doctor in charge. For example, every time the person in charge of the drug trial consults with the doctor in charge and collects trial information, the person in charge of the drug trial organizes the collected trial information and reports the trial information to the pharmaceutical company that has outsourced the business activity. The pharmaceutical company organizes the trial information reported from the outsourcing company and files an application for approval of production and sales of an interested drug.

A supporting device that supports the monitoring task exists. For example, the supporting device is installed in the pharmaceutical company, and doctor information that indicates information on doctors is registered in the supporting device. When the supporting device receives access from the person in charge of the drug trial, the supporting device outputs information of doctors of which the person is in charge. The person in charge of the drug trial selects doctor information of the doctor in charge and enters the trial information collected through the monitoring task in the supporting device. The supporting device associates the doctor information with the trial information entered by the person in charge of the drug trial and stores the doctor information and the trial information. The pharmaceutical company organizes the trial information stored in the supporting device and files the application for the approval.

In addition, a technique for managing information exists. For example, the following technique is disclosed in Japanese Laid-open Patent Publication No. 63-318646. In the technique, in order to handle the occurrence of a failure in an online update process of a bank or the like, a master file is not updated in real time, information is temporarily registered and stored in a file, and a master record is updated at an arbitrary time. In addition, a technique for receiving a request to update data from an administrator and other people and officially updating data approved by the administrator among the data requested to be updated is disclosed in Japanese Laid-open Patent Publication No. 2000-259477.

### SUMMARY

According to an aspect of the invention, an information managing server includes: a memory; and a processor configured to execute a procedure, the procedure comprising: registering, in the memory, stored doctor information including information on doctors, registrant information indicating a registrant who provides a registration request, and registration information indicating a state of registration, in accordance with the registration request, possible states of registration including at least provisional registration and definitive registration, and outputting, in accordance with a doctor information request from a user, associated doctor information that is associated with both the registration information indicating the provisional registration and the registrant information indicating the user, among the stored doctor information in the memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a functional configuration of an information managing server according to the first embodiment;

FIG. 2 is a diagram illustrating an example of information stored in a doctor information storage section;

FIG. 3 is a diagram illustrating an example of a display screen that is displayed on a terminal that is operated by a user;

FIG. 4 is a diagram illustrating an example of a display screen that is displayed on the terminal that is operated by the user;

FIG. 5 is a diagram illustrating an example of a display screen that is displayed on an operating terminal that is operated by an administrator;

FIG. 6 is a diagram illustrating an example of a display screen that is displayed on the operating terminal that is operated by the administrator;

FIG. 7 is a diagram illustrating an example of a display screen that is displayed on the terminal that is operated by the user;

FIG. 8 is a flowchart of a process procedure that is related to provisional registration and executed by the information managing server;

FIG. 9 is a flowchart of a process procedure that is related to an update and executed by the information managing server;

FIG. 10 is a flowchart of a process procedure that is related to a search and executed by the information managing server; and

FIG. 11 is a diagram illustrating an example of a computer that executes an information management program.

### DESCRIPTION OF EMBODIMENTS

The supporting device described as related art may delay the monitoring task. For example, if the doctor information of the doctor in charge is not registered in the supporting device regardless of the fact that the clinical trial is outsourced to the doctor in charge, the supporting device does not receive, from the person in charge of the drug trial, an entry of the trial information collected from the doctor in charge. In this case, the supporting device does not receive, from the person in charge of the drug trial, the entry of the trial information collected from the doctor in charge until the doctor information of the doctor in charge is registered in the supporting device by an administrator. Thus, the monitoring task is delayed.

A technique disclosed herein has been devised in view of the aforementioned problem and provides an information managing server, an information management method and a computer-readable recording medium storing an information management program, which do not delay the monitoring task.

Embodiments of the information managing server disclosed herein, the information management method disclosed herein and the information management program disclosed herein are described in detail with reference to the accompanying drawings. The technique disclosed herein is not limited to the embodiments. The embodiments may be combined without contradicting details of processes.

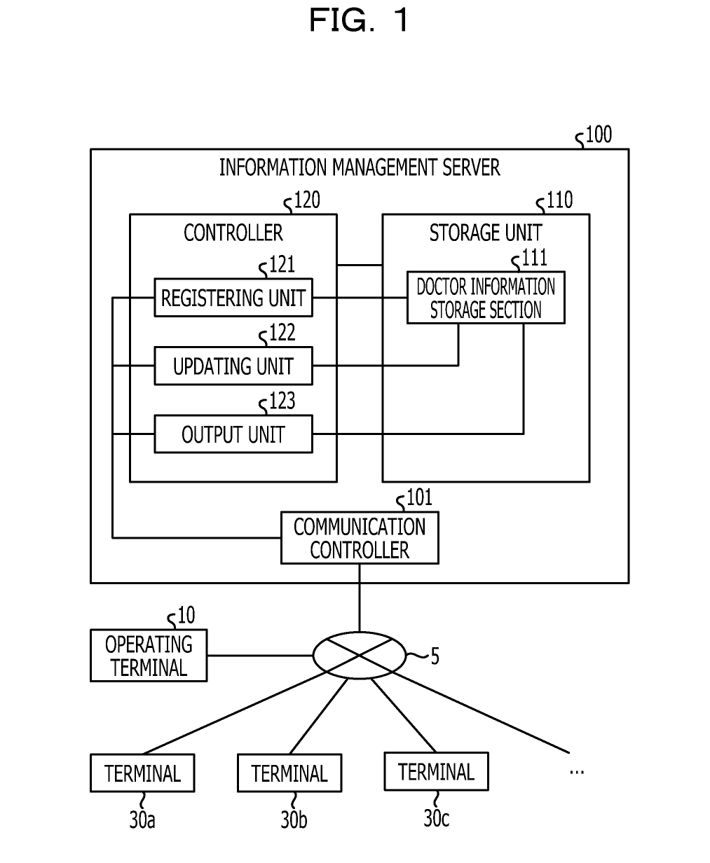

An example of a functional configuration of an information managing server 100 according to the first embodiment is described. FIG. 1 is a block diagram illustrating the functional configuration of the information managing server 100. As illustrated in FIG. 1, the information managing server 100 is connected to an operating terminal 10 and terminals 30a, 30b and 30c through a network 5. For example, the information managing server 100 is a server device that is installed in a pharmaceutical company and manages doctor information on doctors in charge of clinical trials and trial information of the clinical trials. The trial information is collected through monitoring tasks relating to the doctors in charge. As the network 5, any kind of communication network such as the Internet, a local area network (LAN) or a virtual private network (VPN) may be used. The three terminals 30a, 30b and 30c are connected to the information managing server 100. The connection, however, is not limited to the configuration illustrated in FIG. 1. The information managing server 100 may be connected to an arbitrary number of terminals. When the terminals 30a, 30b and 30c are not distinguished from each other, the terminals 30a, 30b and 30c are referred to as terminals 30.

The operating terminal 10 is a terminal that is installed in the pharmaceutical company and operated by an administrator who manages the information managing server 100, for example. The operating terminal 10 corresponds to a personal computer, a workstation or the like. An application that supports various tasks is installed in the operating terminal 10, for example. The various tasks are tasks related to registration or browsing of doctor information and trial information of clinical trials. It is assumed that only the administrator has authority to register doctor information.

The terminals 30 are installed in an outsourcing company that receives outsourced drug trial transfer business activities from the pharmaceutical company, and are operated by users who use the information managing server 100, for example. For example, the terminals 30 correspond to personal computers, workstations or the like. For example, an application that supports various tasks is installed in the terminals 30. The various tasks are tasks related to provisional registration or browsing of doctor information and trial information of clinical trials. The users include a person who is in charge of the drug trial and belongs to the outsourcing company in which the terminals 30 are installed. The users also include a person who is involved with a drug trial business activity and belongs to the pharmaceutical company. The terminals 30 may be installed in the pharmaceutical company.

The information managing server 100 includes a communication controller 101, a storage unit 110 and a controller 120. The communication controller 101 controls communication related to various types of information that is transmitted and received among the operating terminal 10, the terminals 30 and the information managing server 100. An example of the communication controller 101 is a network interface card (NIC).

The storage unit 110 has a doctor information storage section 111, for example. The storage unit 110 corresponds to a storage device such as a semiconductor memory, a hard disk device or an optical disc device. Examples of the semiconductor memory are a random access memory (RAM) and a flash memory.

The doctor information storage section 111 stores doctor information, registration information and registrant information. The doctor information indicates information on doctors. The registration information indicates whether the doctor information has been definitively registered or provisionally registered. The registrant information indicates registrants who have registered the doctor information. For example, a record that includes doctor information is registered in the doctor information storage section 111 by a registering unit 121 (described later) for each of the doctors. The doctor information stored in the doctor information storage section 111 is updated by an updating unit 122 (described later), for example. The doctor information storage section 111 is referenced by the registering unit 121, the updating unit 122 and an output unit 123.

As an example, the doctor information storage section 111 stores data including IDs, doctor codes, doctor names, the registration information and the registrant information, which are associated with each other. The IDs are identifiers that uniquely identify the doctor codes registered in the doctor information storage section 111. The doctor codes indicate registration numbers assigned to the doctors. The doctor names are the names of the doctors. The registration information indicates whether the doctor codes registered in the doctor information storage units 111 have been definitively registered or provisionally registered. In the doctor information storage section 111, the definitive registration indicates a record that has been registered by the administrator and is used by all the users of the information managing servers 100, while the provisional registration indicates a record that has been registered by any of the users and is used by the user who has registered the interested record. The registrant information indicates the registrants who have registered the records of the doctors. The registration information that indicates the provisional registration is represented as “provisional registration information”, while the registration information that indicates the definitive registration is represented as “definitive registration information”. The administrator may access the records registered in the doctor information storage section 111 and indicating the doctors, browse and delete the records and register a record in doctor information storage section 111. The doctor codes and the doctor names are an example of the doctor information.

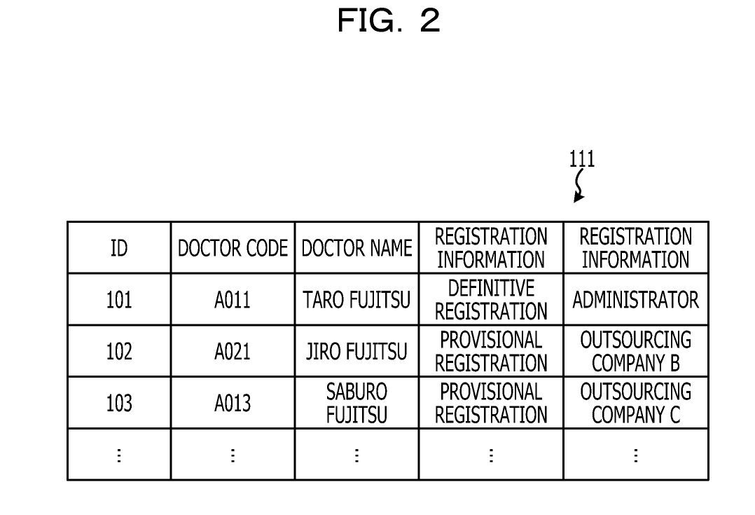

An example of the information stored in the doctor information storage section 111 is described with reference to FIG. 2. FIG. 2 is a diagram illustrating the example of the information stored in the doctor information storage section 111. In a record of a first row illustrated in FIG. 2, an ID “101”, a doctor code “A011”, a doctor name “Taro Fujitsu”, the registration information indicating the “definitive registration” and registrant information indicating the “administrator” are associated with each other. Specifically, the record indicates the definitive registration, and a doctor who has the doctor code “A011” and whose name is Taro Fujitsu is registered by the administrator. In a record of a second row illustrated in FIG. 2, an ID “102”, a doctor code “A021”, a doctor name “Jiro Fujitsu”, the registration information indicating the “provisional registration” and registrant information indicating an “outsourcing company B” are associated with each other. Specifically, the record indicates the provisional registration, and a doctor who has the doctor code “A021” and whose name is Jiro Fujitsu is registered by the outsourcing company B. The doctor information storage section 111 stores data that is IDs, doctor codes, doctor names, the registration information and the registrant information for each of other doctors, while the IDs, the doctor codes, the doctor names, the registration information and the registrant information are associated with each other. As the registrant information, information that identifies individuals who are registrants may be registered. As the registrant information, information that identifies outsourcing companies to which the registrants belong may be registered.

The controller 120 has the registering unit 121, the updating unit 122 and the output unit 123. The functions of the controller 120 may be achieved by an integrated circuit such as an application specific integrated circuit (ASIC) or a field programmable gate array (FPGA). The functions of the controller 120 may be achieved by causing a central processing unit (CPU) to execute a predetermined program.

The registering unit 121 registers the doctor information in the doctor information storage section 111, for example. The registration includes the definitive registration performed by the administrator and the provisional registration performed by the users. A case where the registering unit 121 executes a process related to the provisional registration is described below.

For example, the registering unit 121 associates doctor information, registrant information and registration information with each other and registers the doctor information, the registrant information and the registration information in the doctor information storage section 111. In this case, the registrant information indicates a registrant who has registered the doctor information, and the registration information indicates the provisional registration. The registering unit 121 receives a request to register doctor information from a user who uses the information managing server 100, for example. Then, the registering unit 121 associates the doctor information, registrant information indicating the user as a registrant, the registration information indicating the provisional information with each other. Then, the registering unit 121 registers the doctor information, the registrant information and the registration information in the doctor information storage section 111.

As an example, the registering unit 121 receives a request to register doctor information from any of the terminals 30. The registering unit 121 outputs a provisional registration screen to the terminal 30 that has transmitted the request to register the doctor information. The terminal 30 receives an entry of the doctor information in the received provisional registration screen from a user. When a “register” button of the provisional registration screen is pressed by the user, the terminal 30 transmits, to the information managing server 100, information that indicates that the “register” button of the provisional registration screen has been pressed. In this case, the terminal 30 transmits, to the information managing server 100, the entered doctor information, the provisional registration information indicating the provisional registration, and the registrant information indicating the user of the terminal 30 as a registrant, as well as the information indicating that the “register” button of the provisional registration screen has been pressed.

The registering unit 121 receives, from the terminal 30, the entered doctor information, the provisional registration information, the registrant information and the information indicating that the “register” button of the provisional registration screen has been pressed. The registering unit 121 associates the doctor information, the provisional registration information and the registrant information indicating the user of the terminal 30 as the registrant with each other and registers the doctor information, the provisional registration information and the registrant information in the doctor information storage section 111.

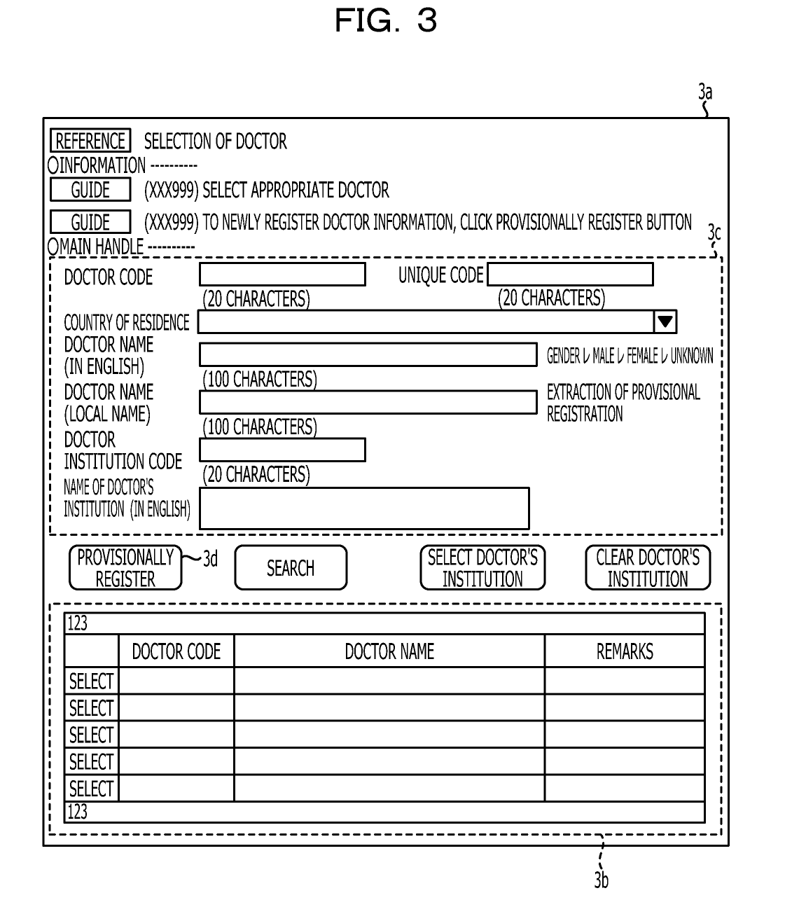

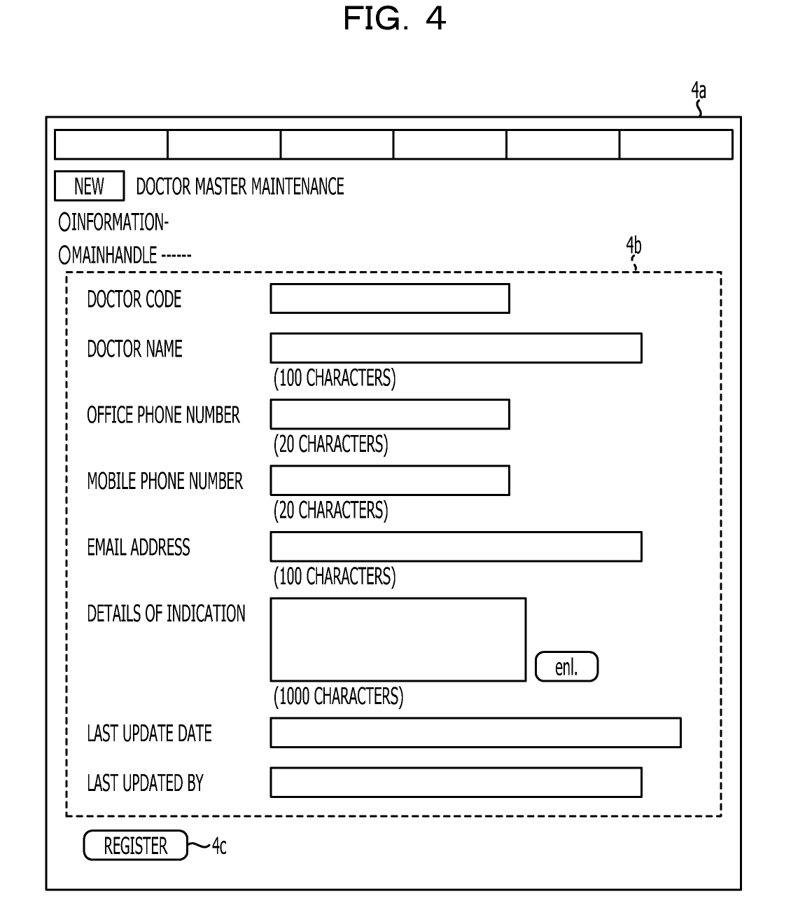

A process related to the provisional registration is described with reference to FIGS. 3 and 4. FIGS. 3 and 4 are diagrams illustrating examples of display screens displayed on the terminal 30 that is operated by the user. A display screen 3a illustrated in FIG. 3 is displayed on the terminal 30 in order to cause the user to select doctor information of a doctor in charge when trial information that indicates a clinical trial and is collected by the user through a monitoring task relating to the doctor in charge is to be registered in the information managing server 100. For example, doctor information of a doctor is displayed in a region 3b of the display screen 3a on the basis of a search criterion entered in a region 3c of the display screen 3a. For example, the user selects the doctor information of the doctor in charge from among displayed doctor information and enters the trial information collected through the monitoring task. If the doctor information of the doctor in charge is not included in the displayed doctor information, the user may press a “provisionally register” button 3d and provisionally register the doctor information.

The examples illustrated in FIGS. 3 and 4 describe a case where the person who is in charge of the drug trial and belongs to the outsourcing company B provisionally registers the doctor information of the doctor who has the doctor code “A021” and whose name is Jiro Fujitsu. For example, when the “provisionally register” button 3d is pressed by the person in charge of the drug trial, the terminal 30 transmits, to the information managing server 100, information that indicates that the “provisionally register” button 3d has been pressed. When receiving, from the terminal 30, the information indicating that the “provisionally register” button 3d has been pressed, the registering unit 121 outputs a provisional registration screen 4a illustrated in FIG. 4 to the terminal 30. When receiving the provisional registration screen 4a, the terminal 30 displays the provisional registration screen 4a. The terminal 30 receives entries of the doctor code “A021” and doctor name “Jiro Fujitsu” in a region 4b of the provisional registration screen 4a from the person in charge of the drug trial. When a “register” button 4c of the provisional registration screen 4a is pressed by the person in charge of the drug trial, the terminal 30 transmits, to the information managing server 100, information that indicates that the “register” button 4c of the provisional registration screen 4a has been pressed. In this case, the terminal 30 transmits, to the information managing server 100, the doctor code “A021”, the doctor name “Jiro Fujitsu”, the provisional registration information and information indicating the person in charge of the drug trial and belonging to the outsourcing company B, as well as the information indicating that the “register” button 4c of the provisional registration screen 4a has been pressed. The registering unit 121 receives, from the terminal 30, the doctor code “A021”, the doctor name “Jiro Fujitsu”, the provisional registration information, the information indicating the person in charge of the drug trial and belonging to the outsourcing company B and the information indicating that the “register” button 4c of the provisional registration screen 4a has been pressed. The registering unit 121 associates the ID “102”, the doctor code “A021”, the doctor name “Jiro Fujitsu”, the provisional registration information and the information indicating the person in charge of the drug trial and belonging to the outsourcing company B with each other and registers, in the doctor information storage section 111, the ID “102”, the doctor code “A021”, the doctor name “Jiro Fujitsu”, the provisional registration information and the information indicating the person in charge of the drug trial and belonging to the outsourcing company B.

The updating unit 122 updates registration information stored in the doctor information storage section 111 from the provisional registration to the definitive registration, for example. The updating unit 122 receives, from the administrator who manages the information managing server 100, a request to update registration information associated with doctor information from the provisional registration to the definitive registration, and updates the registration information from the provisional registration to the definitive registration, for example.

For example, the updating unit 122 receives, from the operating terminal 10, a request to update registration information from the provisional registration to the definitive registration. The updating unit 122 outputs a registration screen to the operating terminal 10 that has transmitted the request to update the registration information from the provisional registration to the definitive registration. The operating terminal 10 receives an entry of doctor information in the received registration screen from a user. When a “register” button of the registration screen is pressed by the administrator, the operating terminal 10 transmits, to the information managing server 100, information that indicates that the “register” button of the registration screen has been pressed. In this case, the operating terminal 10 transmits the entered doctor information and information indicating whether or not the provisional registration has been determined, as well as the information indicating that the “register” button of the registration screen has been pressed.

The updating unit 122 receives, from the operating terminal 10, the information that indicates that the “register” button of the registration screen has been pressed. The updating unit 122 determines whether or not the provisional registration of the registration screen has been determined. If the provisional registration of the registration screen has been determined, the updating unit 122 updates the provisional registration information associated with the doctor information corresponding to a pressed “select” button to the definitive registration. Then, the updating unit 122 updates the doctor information received from the operating terminal 10. If the provisional registration of the registration screen has not been determined, the updating unit 122 updates the doctor information corresponding to the pressed “select” button.

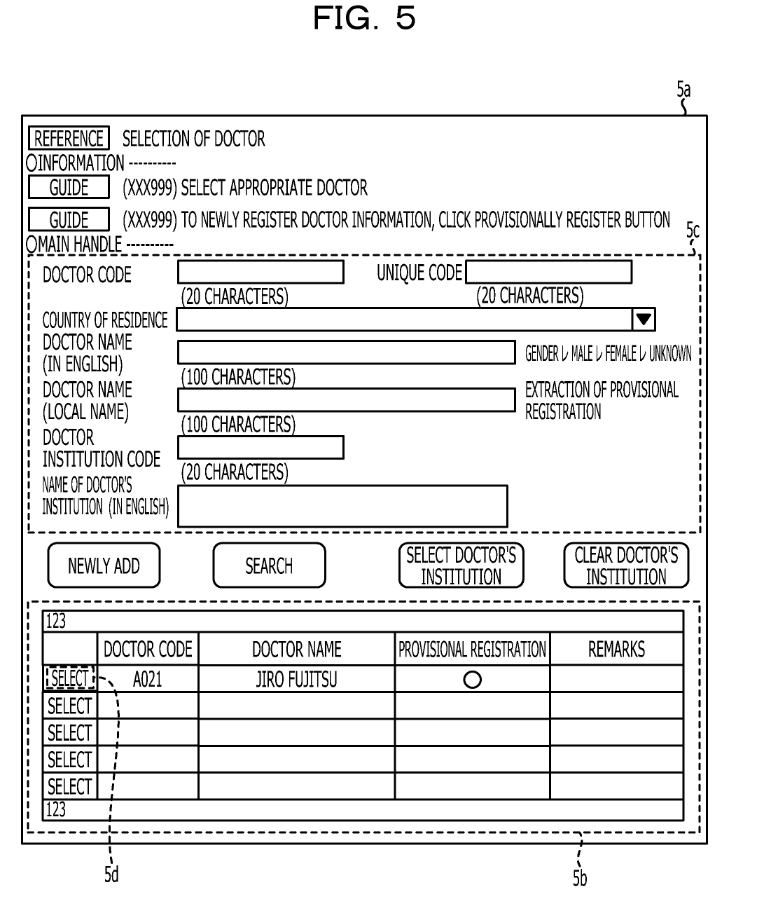

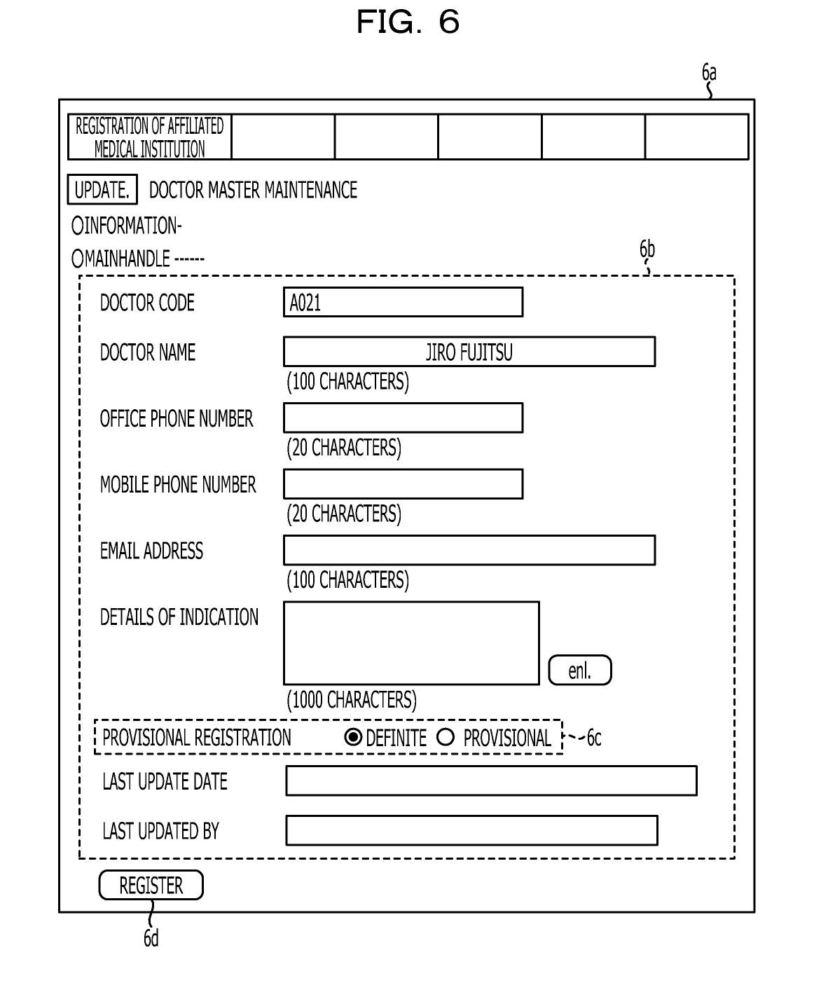

A process that is related to the update is described below with reference to FIGS. 5 and 6. FIGS. 5 and 6 are diagrams illustrating examples of display screens displayed on the operating terminal 10 that is operated by the administrator. A display screen 5a illustrated in FIG. 5 is displayed on the operating terminal 10 in order for the administrator to manage the doctor information stored in the doctor information storage section 111. For example, doctor information is displayed in a region 5b of the display screen 5a on the basis of a search criterion entered in a region 5c of the display screen 5a.

The examples illustrated in FIGS. 5 and 6 describe a case where the administrator updates the doctor information of the doctor who has the doctor code “A021” and whose name is Jiro Fujitsu from the provisional registration to the definitive registration. The operating terminal 10 receives an operation of pressing a “select” button 5d by the administrator. The operating terminal 10 transmits, to the information managing server 100, information indicating that the “select” button 5d has been pressed. When receiving the information indicating that the “select” button 5d has been pressed, the updating unit 122 outputs a registration screen 6a illustrated in FIG. 6 to the operating terminal 10.

When receiving the registration screen 6a, the operating terminal 10 displays the received registration screen 6a. The doctor code “A021” and the doctor name “Jiro Fujitsu” that are the registered doctor information are displayed in a region 6b of the registration screen 6a. In a region 6c of the registration screen 6a, a “provisional” box that indicates the doctor information is provisionally registered is checked. As illustrated in FIG. 6, the operating terminal 10 receives, from the administrator, an operation of checking a “definite” box that indicates that the provisional registration is determined. Then, when a “register” button 6d of the registration screen 6a is pressed by the administrator, the operating terminal 10 transmits, to the information managing server 100, information that indicates that the “register” button 6d of the registration screen 6a has been pressed. In this case, the operating terminal 10 transmits, to the information managing server 100, information indicating whether the “definite” box or the “provisional” box is checked in the region 6c, as well as the information indicating that the “register” button 6d of the registration screen 6a has been pressed. When the doctor information that is displayed in the region 6b is changed, the operating terminal 10 also transmits the changed doctor information to the information managing server 100.

When receiving, from the operating terminal 10, the information indicating that the “register” button 6d of the registration screen 6a has been pressed, the updating unit 122 determines whether the “definite” box or the “provisional” box has been checked in the region 6c. If the “definite” box has been checked in the region 6c, the updating unit 122 updates the provisional registration information associated with doctor information corresponding to the “select” button 5d and stored in the doctor information storage section 111 to the definitive registration information and updates the doctor information to the changed doctor information.

The output unit 123 outputs doctor information. For example, if registration information associated with doctor information stored in the doctor information storage section 111 indicates the provisional registration, the output unit 123 outputs the doctor information to a certain terminal 30 used by a registrant who has registered the doctor information. If the registration information associated with the doctor information stored in the doctor information storage section 111 indicates the definitive registration, the output unit 123 outputs the doctor information to the certain terminal 30 and the other terminals used by users other than the registrant.

For example, when receiving a request to search doctor information from a certain terminal 30, the output unit 123 extracts definitively registered doctor information from the doctor information storage section 111. The output unit 123 extracts doctor information that is among the definitively registered doctor information and associated with registrant information that matches a user of the certain terminal 30. The output unit 123 specifies doctor information that is among the extracted doctor information and corresponds to a search criterion included in the request to search the doctor information. Then, the output unit 123 outputs the specified doctor information to the terminal 30 that has transmitted the request to search the doctor information. When receiving the doctor information, the terminal 30 displays the received doctor information.

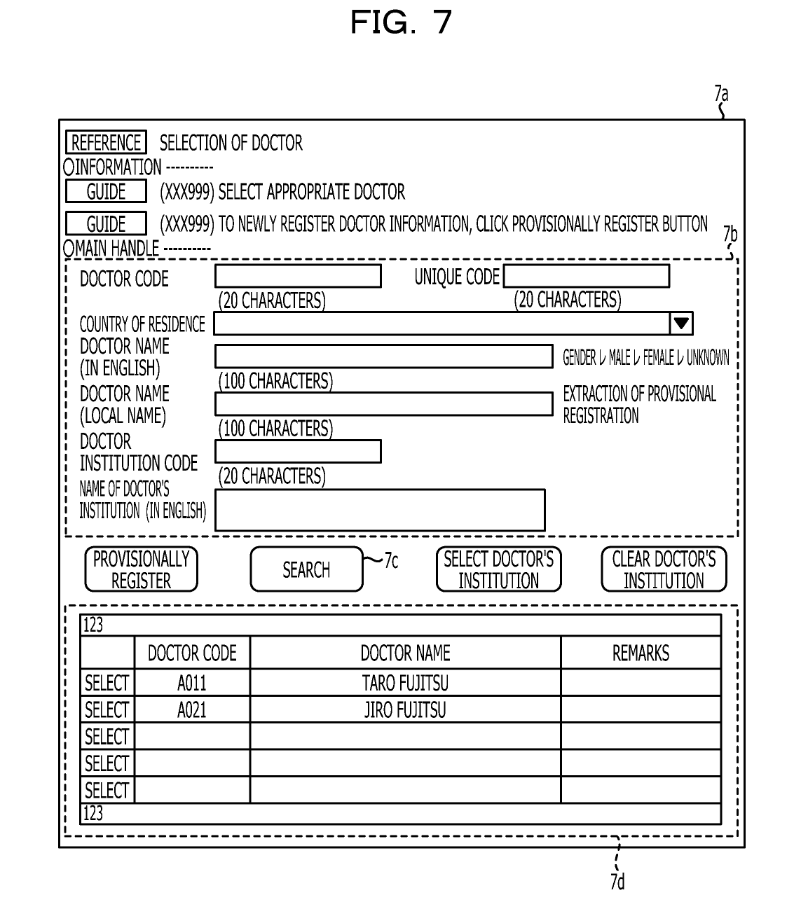

A process that is related to the search is described with reference to FIG. 7. FIG. 7 is a diagram illustrating an example of a display screen displayed on the terminal 30 that is operated by the user. A display screen 7a illustrated in FIG. 7 is displayed on the terminal 30 in order to cause the user to select doctor information of a doctor in charge when trial information that indicates a clinical trial and is collected by the user through a monitoring task relating to the doctor in charge is to be registered in the information managing server 100. For example, the terminal 30 receives an entry of a search criterion in a region 7b of the display screen 7a. The terminal 30 receives an operation of pressing a “search” button 7c. When the “search” button 7c is pressed, the terminal 30 transmits, to the information managing server 100, the search criterion, information indicating the user of the terminal 30 and information indicating that the “search” button 7c has been pressed. The search criterion may not be entered. A case where a search criterion is not entered is described below.

The example illustrated in FIG. 7 describes a case where the person who is in charge of the drug trial and belongs to the outsourcing company B registers, in the information managing server 100, the trial information that indicates the clinical trial and has been collected through the monitoring task. The output unit 123 receives, from a terminal 30, information indicating the outsourcing company B and information indicating that the “search” button 7c has been pressed. The output unit 123 extracts, from the doctor information storage section 111, doctor information associated with definitive registration information. In the example illustrated in FIG. 2, the output unit 123 extracts the record corresponding to the doctor who has the ID “101”. The output unit 123 specifies doctor information that is among doctor information associated with the provisional registration information and is associated with registrant information that matches the user of the terminal 30. In the example illustrated in FIG. 2, the output unit 123 extracts the record of the doctor who has the ID “102” associated with the registration information indicating the “provisional registration” and the registrant information indicating the “outsourcing company B”. The output unit 123 outputs the specified doctor information to the terminal 30 of the outsourcing company B, while the “search” button 7c of the terminal 30 has been pressed. When receiving the doctor information, the terminal 30 displays the received doctor information in a region 7d illustrated in FIG. 7.

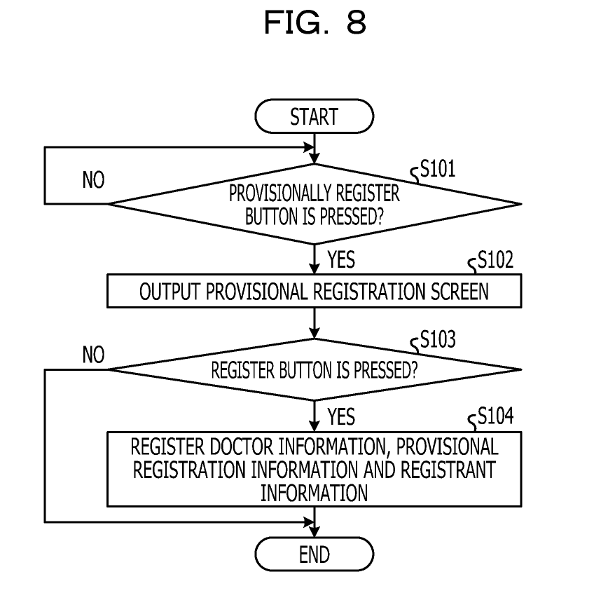

Next, process procedures that are executed by the information managing server 100 according to the first embodiment are described. FIG. 8 is a flowchart of a process procedure that is related to the provisional registration and executed by the information managing server 100. The process procedure illustrated in FIG. 8 is executed when the registering unit 121 receives information indicating that the “provisionally register” button has been pressed.

As illustrated in FIG. 8, when receiving the information indicating that the “provisionally register” button has been pressed (Yes in S101), the registering unit 121 outputs the provisional registration screen to a terminal 30 that has transmitted the information indicating that the “provisionally register” button has been pressed (in S102). The terminal 30 receives an entry of doctor information in the received provisional registration screen from a user. When the “register” button of the provisional registration screen is pressed by the user, the terminal 30 transmits, to the information managing server 100, information indicating that the “register” button of the provisional registration screen has been pressed. In this case, the terminal 30 transmits, to the information managing server 100, the entered doctor information, provisional registration information indicating the provisional registration, registrant information indicating the user of the terminal 30 as a registrant, as well as the information indicating that the “register” button of the provisional registration screen has been pressed. The registering unit 121 stands by until receiving, from the terminal 30, the information indicating that the “provisionally register” button has been pressed (No in S101).

When receiving, from the terminal 30, the information indicating that the “register” button has been pressed (Yes in S103), the registering unit 121 associates the doctor information, the provisional registration information and the registrant information with each other and registers the doctor information, the provisional registration information and the registrant information in the doctor information storage section 111 (in S104). The registering unit 121 stands by until receiving, from the terminal 30, the information indicating that the “register” button of the provisional registration screen has been pressed (No in S103).

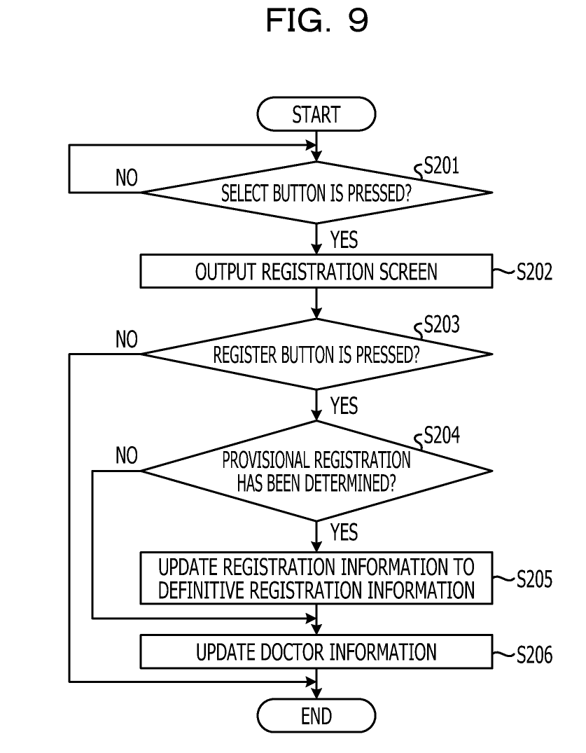

FIG. 9 is a flowchart of a process procedure that is related to the update and executed by the information managing server 100. For example, the process procedure illustrated in FIG. 9 is executed when the updating unit 122 receives information indicating that a “select” button has been pressed.

As illustrated in FIG. 9, when receiving, from the operating terminal 10, information indicating that a “select” button has been pressed (Yes in S201), the updating unit 122 outputs the registration screen to the operating terminal 10 that has transmitted the information indicating that the “select” button has been pressed (in S202). The operating terminal 10 receives an entry of doctor information in the received registration screen from the user. When the “register” button of the registration screen has been pressed by the administrator, the operating terminal 10 transmits, to the information managing server 100, information indicating that the “register” button of the registration screen has been pressed. In this case, the operating terminal 10 transmits, to the information managing server 100, the entered doctor information and information indicating whether or not the provision registration has been determined, as well as the information indicating that the “register” button of the registration screen has been pressed. The updating unit 122 stands by until receiving, from the operating terminal 10, the information indicating that the “register” button has been pressed (No in S201).

When receiving, from the operating terminal 10, the information indicating that the “register” button of the registration screen has been pressed (Yes in S203), the updating unit 122 determines whether or not the provisional registration of the registration screen has been determined (in S204).

If the provisional registration of the registration screen has been determined (Yes in S204), the updating unit 122 updates provisional registration information associated with the doctor information corresponding to the pressed “select” button to the definitive registration information (in S205). Then, the updating unit 122 updates the doctor information received from the operating terminal 10 (in S206). The updating unit 122 stands by until receiving, from the operating terminal 10, the information indicating that the “register” button of the registration screen has been pressed (No in S203).

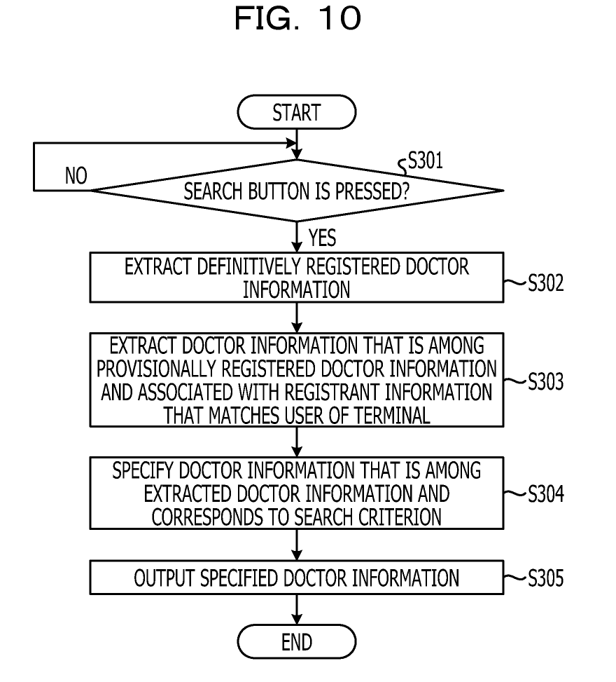

FIG. 10 is a flowchart of a process procedure that is related to the search and executed by the information managing server 100. The process procedure illustrated in FIG. 10 is executed when the output unit 123 receives information indicating that the “search” button has been pressed, for example.

As illustrated in FIG. 10, when receiving, from the terminal 30, information indicating that the “search” button has been pressed (Yes in S301), the output unit 123 extracts definitively registered doctor information from the doctor information storage section 111 (in S302). The terminal 30 transmits, to the information managing server 100, information indicating the user of the terminal 30 and a search criterion, as well as the information indicating that the “search” button has been pressed. Thus, the output unit 123 receives, from the terminal 30, the information indicating the user of the terminal 30 and the search criterion, as well as the information indicating that the “search” button has been pressed.

The output unit 123 extracts doctor information that is among provisionally registered doctor information and associated with registrant information that matches the user of the terminal 30 (in S303). The output unit 123 specifies doctor information that is among the extracted doctor information and corresponds to the search criterion (in S304). The output unit 123 outputs the specified doctor information to the terminal 30 on which the “search” button has been pressed (in S305). When receiving the doctor information, the terminal 30 displays the received doctor information.

Next, effects of the information managing server 100 according to the first embodiment are described. The information managing server 100 associates doctor information indicating information on doctors, registration information indicating the provisional registration or the definitive information, and registrant information indicating registrants who have registered the doctor information with each other, and stores the doctor information, the registration information and the registrant information. The information managing server 100 associates the doctor information, the registrant information (indicating the registrants who have registered the doctor information), the registration information indicating the provisional registration with each other and registers, in the storage unit 110, the doctor information, the registrant information, the registration information indicating the provisional registration. The information managing server 100 updates the registration information stored in the storage unit 110 from the provision registration to the definitive registration. If registration information associated with doctor information stored in the storage unit 110 indicates the provisional registration, the information managing server 100 outputs the doctor information to a terminal of a registrant who has registered the doctor information. If the registration information indicates the definitive registration, the information managing server 100 outputs the doctor information to other terminals and the terminal of the registrant who has registered the doctor information. Thus, the information managing server 100 achieves an operation that does not delay the monitoring task.

For example, the information managing server 100 receives a request to register doctor information from a user who uses the information managing server 100. Then, the information managing server 100 associates the received doctor information, registrant information indicating the user as a registrant and registration information indicating the provisional registration with each other and stores the doctor information, the registrant information and the registration information. The information managing server 100 receives, from the administrator who manages the information managing server 100, a request to update the registration information associated with the doctor information from the provisional registration to the definitive registration. Then, the information managing server 100 updates the registration information from the provisional registration to the definitive registration. Thus, even if doctor information of a doctor in charge is not registered by the administrator of the information managing server 100, the doctor information may be provisionally registered in the information managing server 100 by a person who is in charge of a drug trial and belongs to an outsourcing company. Thus, the information managing server 100 may use the doctor information without waiting for definitive registration by the administrator. The monitoring task, therefore, is not delayed.

### Second Embodiment

The first embodiment is described above. The technique disclosed herein may be achieved in another embodiment. The other embodiment is described below.

All or a part of the processes that are described in the first embodiment and automatically executed may be manually executed. All or a part of the processes that are described in the first embodiment and manually executed may be automatically executed using a known method. The process procedures, control procedures, specific names and information including various types of parameters and data, which are described in the first embodiment or illustrated in the drawings, may be arbitrarily changed unless otherwise specified.

The constituent elements of the information managing server 100 illustrated in FIG. 1 are functionally conceptual and may not be physically configured as illustrated in the drawings. Specifically, specific forms of separation and integration of the constituent elements of the managing server 100 are not limited to those illustrated in FIG. 1, and all or a part of the constituent elements of the information managing server 100 may be functionally or physically separated or integrated on an arbitrary basis on the basis of various types of loads or usage statuses. For example, the information managing server 100 may not store the doctor information storage section 111. The doctor information storage section 111 may be stored in an external storage device arranged outside the information managing server 100.

Program

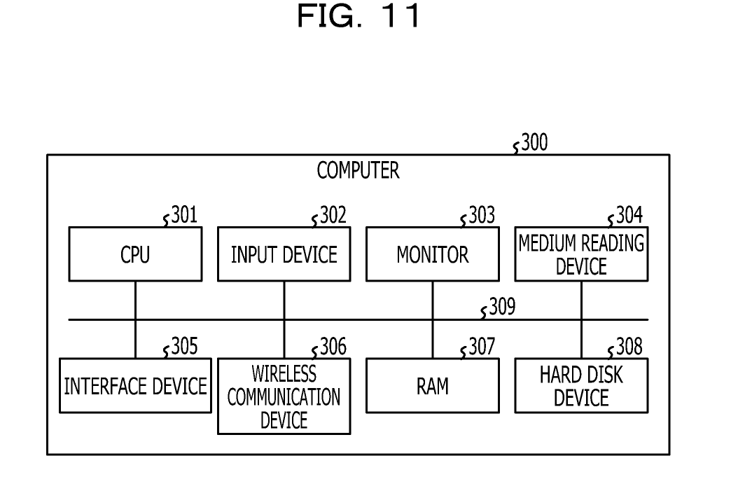

FIG. 11 is a diagram illustrating an example of a computer that executes the information management program. As illustrated in FIG. 11, a computer 300 has a CPU 301, an input device 302 and a monitor 303. The CPU 301 executes various calculation processes. The input device 302 receives an entry of data from a user. The computer 300 also has a medium reading device 304, an interface device 305 and a wireless communication device 306. The medium reading device 304 reads a program and the like from a recording medium. The interface device 305 connects the computer 300 to another device. The wireless communication device 306 wirelessly connects the computer 300 to another device. The computer 300 has a hard disk device 308 and a random access memory (RAM) 307 that temporarily stores various types of information. The devices 301 to 308 are connected to each other through a bus 309.

The hard disk device 308 stores the information management program that has the same functions as the processing units that are the registering unit 121, the updating unit 122 and the output unit 123 that are illustrated in FIG. 1. The hard disk device 308 stores various types of data that is used to achieve the information management program.

The CPU 301 reads the various programs stored in the hard disk device 308, loads the programs into the RAM 307, executes the programs and thereby executes the various processes. The programs may cause the computer 300 to function as the registering unit 121, the updating unit 122 and the output unit 123 that are illustrated in FIG. 1.

The information management program may not be stored in the hard disk device 308. The information management program may be stored in a computer-readable recording medium, and the computer 300 may read the information management program from the computer-readable recording medium and execute the information management program. The computer-readable recording medium corresponds to a portable recording medium such as a CD-ROM, a digital versatile disc (DVD) or a universal serial bus (USB) memory, a semiconductor memory such as a flash memory, a hard disk drive or the like. The information management program may be stored in a device connected to a public line, the Internet, a local area network (LAN), a wide area network (WAN) or the like, and the computer 300 may read the information management program from the device and execute the information management program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information managing server comprising:
a memory; and
a processor configured to execute a procedure, the procedure comprising:
registering, in the memory, stored doctor information including information on doctors, registrant information indicating a registrant who provides a registration request, and registration information indicating a state of registration, in accordance with the registration request, possible states of registration including at least provisional registration and definitive registration, and
outputting, in accordance with a doctor information request from a user, associated doctor information that is associated with both the registration information indicating the provisional registration and the registrant information indicating the user, among the stored doctor information in the memory.

2. The information managing server according to claim 1, the procedure further comprising:
storing, in the memory, received information that is received from a doctor indicated by the associated doctor information, when the associated doctor information is selected by the user.

3. The information managing server according to claim 1, the procedure further comprising:
outputting, in accordance with the doctor information request from the user, registered doctor information that is associated with the registration information indicating the definitive registration among the stored doctor information in the memory.

4. The information managing server according to claim 1, the procedure further comprising:
updating the registration information stored in the memory from the provisional registration to the definitive registration, when an instruction from an administrator who manages the information managing server is received.

5. The information managing server according to claim 4,
wherein the updating outputs provisional doctor information that is associated with the registration information indicating the provisional registration, and updates the registration information, that is associated with specified doctor information specified by the administrator, to the definitive registration.

6. An information management method executed by a computer, comprising:
registering, in a memory, stored doctor information including information on doctors, registrant information indicating a registrant who provides a registration request, and registration information indicating a state of registration, in accordance with the registration request, possible states of registration including at least provisional registration and definitive registration, and
outputting, in accordance with a doctor information request from a user, associated doctor information that is associated with both the registration information indicating the provisional registration and the registrant information indicating the user, among the stored doctor information registered in the memory.

7. The information management method according to claim 6, further comprising:
storing, in the memory, received information that is received from a doctor indicated by the associated doctor information, when the associated doctor information is selected by the user.

8. The information management method according to claim 6, further comprising:
outputting, in accordance with the doctor information request from the user, registered doctor information that is associated with the registration information indicating the definitive registration among the stored doctor information in the memory.

9. The information management method according to claim 6, further comprising:
updating the registration information stored in the memory from the provisional registration to the definitive registration, when an instruction from an administrator who manages the information managing server is received.

10. The information management method according to claim 9,
wherein the updating outputs provisional doctor information that is associated with the registration information indicating the provisional registration, and updates the registration information, that is associated with specified doctor information specified by the administrator, to the definitive registration.

11. A computer-readable recording medium storing an information management program for causing a computer to execute a procedure, the procedure comprising:
registering, in a memory, stored doctor information including information on doctors, registrant information indicating a registrant who provides a registration request, and registration information indicating a state of registration, in accordance with the registration request, possible states of registration including at least provisional registration and definitive registration, and
outputting, in accordance with a doctor information request from a user, associated doctor information that is associated with both the registration information indicating the provisional registration and the registrant information indicating the user, among the stored doctor information registered in the memory.

12. The computer-readable recording medium according to claim 11, the procedure further comprising:
storing, in the memory, received information that is received from a doctor indicated by the associated doctor information, when the associated doctor information is selected by the user.

13. The computer-readable recording medium according to claim 11, the procedure further comprising:
outputting, in accordance with the doctor information request from the user, registered doctor information that is associated with the registration information indicating the definitive registration among the stored doctor information in the memory.

14. The computer-readable recording medium according to claim 11, the procedure further comprising:
updating the registration information stored in the memory from the provisional registration to the definitive registration, when an instruction from an administrator who manages the information managing server is received.

15. The computer-readable recording medium according to claim 14,
wherein the updating outputs provisional doctor information that is associated with the registration information indicating the provisional registration, and updates the registration information, that is associated with specified doctor information specified by the administrator, to the definitive registration.
